(19) United States
(12) Patent Application Publication
(10) Pub. No.: US 2026/0245951 A1
(43) Pub. Date: Aug. 20, 2026

(54) POSITIVE ELECTRODE AND LITHIUM ION SECONDARY BATTERY

(71) Applicant: TOYOTA JIDOSHA KABUSHIKI KAISHA, Toyota-shi (JP)

(72) Inventor: Yudai HASEGAWA, Toyota-shi (JP)

(73) Assignee: TOYOTA JIDOSHA KABUSHIKI KAISHA, Toyota-shi (JP)

(21) Appl. No.: 19/453,295

(22) Filed: Jan. 20, 2026

(30) Foreign Application Priority Data
Feb. 19, 2025 (JP) 2025-025358

(51) Int. Cl. H01M 10/0525; H01M 4/02; H01M 4/36; H01M 4/58; H01M 4/62

(52) U.S. Cl. CPC H01M 10/0525; H01M 4/366; H01M 4/5825; H01M 4/625; H01M 2004/028

(57) ABSTRACT

A positive electrode of a lithium ion secondary battery includes a positive electrode mixture layer including a first region opposed to a separator, the first region including a first particle including an olivine-type compound having a first carbonaceous coating; and a second region opposed to a current collector, the second region including a second particle including an olivine-type compound having a second carbonaceous coating. A first carbon content, which is a mass ratio of carbon based on the first carbonaceous coating in the first particle, is smaller than a second carbon content, which is a mass ratio of carbon based on the second carbonaceous coating in the second secondary particle.

### CROSS-REFERENCE TO RELATED APPLICATION

This application claims priority to Japanese Patent Application No. 2025-025358 filed on Feb. 19, 2025. The disclosure of the above-identified application, including the specification, drawings, and claims, is incorporated by reference herein in its entirety.

### BACKGROUND

### 1. Technical Field

The technology disclosed in the present specification relates to a positive electrode, a lithium ion secondary battery, and the like.

### 2. Description of Related Art

An olivine-type compound such as LiMnFePO₄ (LMFP) is used as an active material of a positive electrode of a lithium ion secondary battery. Japanese Unexamined Patent Application Publication No. 2020-53332 (JP 2020-53332 A) indicates that in active material particles that are core-shell type LMFP secondary particles, the carbonaceous coating of LMFP particles on the surface side is thinner than the carbonaceous coating of LMFP particles on the center side. JP 2020-53332 A indicates that with such a structure, excellent cycle characteristics and capacity maintenance at low temperatures are obtained by maintaining electronic conductivity by retaining contact between primary particles, even when a crystal volume changes due to a charge-discharge reaction of LMFP.

### SUMMARY

However, the inventors have found that there is still room for improvement in cycle characteristics.

The present specification provides a positive electrode, a lithium ion secondary battery, and the like capable of effectively improving cycle characteristics.

The technology disclosed in the present specification is embodied in the following positive electrode and lithium ion secondary battery.
[1] A positive electrode of a lithium ion secondary battery, including:
   a positive electrode mixture layer, in which:
   the positive electrode mixture layer includes
   a first region that faces a separator, the first region containing a first particle containing an olivine-type compound having a first carbonaceous coating, and
   a second region that faces a current collector, the second region containing a second particle containing an olivine-type compound having a second carbonaceous coating; and
   a first carbon content that is a mass ratio of carbon in the first particle based on the first carbonaceous coating is smaller than a second carbon content that is a mass ratio of carbon in the second particle based on the second carbonaceous coating.
[2] The positive electrode according to [1], in which the first region contains a secondary particle of the first particle, and the second region contains a secondary particle of the second particle.
[3] The positive electrode according to [1] or [2], in which the first carbon content of the first particle is 2.5 mass % or less.
[4] The positive electrode according to any one of [1] to [3], in which a basis weight of the positive electrode mixture layer is 20 mg/cm² or more.
[5] A lithium ion secondary battery including the positive electrode according to any one of [1] to [4].

In the positive electrode mixture layer of the positive electrode, the first carbon content in the first particle based on the first carbonaceous coating on the separator side is smaller than the second carbon content in the second particle based on the second carbonaceous coating on the current collector side. Therefore, it is possible to reduce the diffusion resistance of lithium ions on the separator side, and in particular, it is possible to contribute to excellent cycle characteristics for a long time.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an example of a cell of a lithium ion secondary battery disclosed herein;

FIG. 2 is a diagram schematically showing the composite layers of the positive electrode disclosed herein; and

FIG. 3 is a diagram schematically showing a manufacturing process of a positive electrode disclosed in the present specification.

### DETAILED DESCRIPTION OF EMBODIMENTS

The present disclosure relates to a positive electrode for a lithium ion secondary battery, a lithium ion secondary battery, and the like. According to the positive electrode disclosed in the present specification, with respect to the active material particles of the olivine-type compound, the carbon content based on the carbonaceous coating is lowered on the separator side and is increased on the current collector side. The carbon content composition is different in the thickness direction of the positive electrode mixture layer.

Hereinafter, a positive electrode, a lithium ion secondary battery, and the like will be described with reference to the drawings as appropriate.

### Positive Electrode of a Lithium Ion Secondary Battery

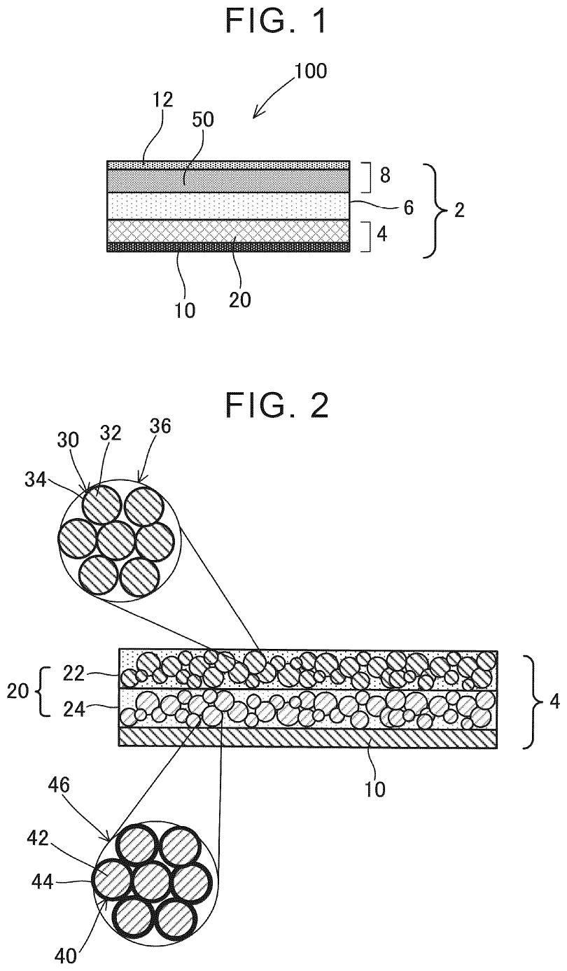

FIG. 1 schematically illustrates an example of a cell 2 of a lithium ion secondary battery (hereinafter, also simply referred to as a secondary battery) 100 disclosed in the present specification. The secondary battery 100 generally has a structure in which the cells 2 are stacked. The cell 2 includes a positive electrode 4, a separator 6, and a negative electrode 8. Further, the cell 2 includes a positive electrode current collector 10 and a negative electrode current collector 12. The positive electrode 4 includes a positive electrode mixture layer 20, and the negative electrode 8 includes a negative electrode mixture layer 50. The positive electrode 4 may be intended to include a positive electrode mixture layer 20 and a positive electrode current collector 10. In some cases, the negative electrode 8 is intended to include the negative electrode mixture layer 50 and the negative electrode current collector 12.

The separator 6 is not particularly limited, but is made of a known material such as a polyolefin-based microporous membrane having fine pores formed therein. The separator is impregnated with a liquid electrolyte including a lithium salt such as lithium hexafluoride phosphate using organic solvents such as ethylene carbonate (EC), dimethyl carbonate (DMC), and diethyl carbonate (DEC) as a medium. Alternatively, a gel electrolyte or a solid electrolyte layer may be used. The negative electrode 8 of the secondary battery 100 may include a negative electrode mixture layer and a current collector of a negative electrode made of a known material and a configuration as appropriate. The positive electrode current collector 10 is not particularly limited, but for example, a known current collector such as a metal or an alloy foil containing aluminum, nickel, or the like can be used as appropriate. As for the negative electrode current collector 12, a known current collector can be used as appropriate.

As shown in FIG. 2, the positive electrode mixture layer (hereinafter, also simply referred to as a mixture layer) 20 includes a first region 22 opposed to the separator 6 in the secondary battery 100 and a second region 24 opposed to the current collector 10. The first region 22 and the second region 24 each have an arbitrary thickness in the thickness direction of the mixture layer 20. For example, the first region 22 and the second region 24 may be provided so as to be divided into two portions in the thickness direction of the mixture layer 20, or may be provided between the first region 22 and the second region 24, and may include a region including a positive electrode active material in an arbitrary composition.

### First Region

The first region 22 contains the first particles 30. The first particle 30 has a particle 32 containing an olivine-type compound and a carbonaceous coating 34 covering at least a part of the surface thereof. Particles 32 contain 90 mass % or more of the olivine-type compound, 95 mass % or more, 98 mass % or more, and 99 mass % or more. The first particle 30 may be, for example, a particle containing 1% by mass or less of impurities and the balance of which is made of an olivine-type compound. The olivine-type compound will be described later.

The carbonaceous coating 34 contributes to the improvement of the electron conductivity. The carbonaceous coating 34 contains a carbonaceous material. Such carbonaceous materials include various carbonaceous materials known in such active material particles. Examples include, but are not limited to, amorphous carbon, carbon black, carbon nanotubes, graphene, graphite, and semi-graphite. The olivine-type compound particles including the carbonaceous coating 34 can be obtained by a known method.

Since the first particles 30 comprise the carbonaceous coating 34, the first particles 30 contain a certain amount of carbon. The carbon content of the first particles 30 based on the carbonaceous coating 34 is not particularly limited, but is preferably lower than the carbon content of the second particles 40 of the second region 24 described later based on the carbonaceous coating 44. This is because the lithium ion diffusivity is improved on the separator 6 side. For example, the carbon content of the first particles 30 is 2.5 mass % or less. This is because when the content is less than or equal to 2.5 mass %, the diffusibility of lithium ions is hardly significantly impaired by the carbonaceous coating 34. The carbon content may be, for example, 2.0 mass % or less, 1.8 mass % or less, 1.6 mass % or less, 1.4 mass % or less, 1.2 mass % or less. The carbon content is, for example, 0.5 mass % or more, 0.6 mass % or more, 0.8 mass % or more, 1.0 mass % or more, 1.2 mass % or more, and 1.5 mass % or more. The carbon content is calculated as the mass ratio of carbon to the total mass of the first particles 30. The carbon content can be measured using a carbon-sulfur analyzer (CS meter).

The first particles 30 may be primary particles, and the primary particles may aggregate to form the secondary particles 36 as a so-called granulated body. When the secondary particles 36 are configured, a diffusion path of lithium ions is easily secured in some cases. In addition, the filling property may be improved.

When the first particles 30 constitute the secondary particles 36 as the primary particles, for example, the mean particle diameter of the first particles 30 is not particularly limited, but may be 40 nm or more. Further, for example, 50 nm or more, 60 nm or more, 80 nm or more. The mean particle diameter of the first particles 30 is also, for example, less than or equal to 150 nm and less than or equal to 100 nm. The average particle diameter of the secondary particles 36 is not particularly limited, but may be, for example, 1 μm or more and 20 μm or less, 2 μm or more and 15 μm or less. The mean particle diameter of the first particles 30 can be determined by small-angle X-ray scattering (Small Angle X-ray Scattering: SAXS). The mean particle diameter of the secondary particles 36 can be determined as D₅₀ (on a volume basis) by the laser diffraction/scattering method.

The shape of the first particles 30 is not particularly limited, but is, for example, spherical. The secondary particles 36 are not particularly limited, but are, for example, spherical.

In the case where the first particles 30 constitute the secondary particles 36, the above-described carbon content is directly applied to the secondary particles 36.

The positive electrode active material in the first region 22 may include an olivine-type compound or a known layered rock salt-type oxide other than the first particles 30 or the secondary particles 36 thereof. Preferably, the content of the first particles 30 or the secondary particles 36 thereof is, for example, 80% by mass or more, 85% by mass or more, 90% by mass or more, 95% by mass or more, 97% by mass or more, 98% by mass or more, or 99% by mass or more with respect to the total mass of the positive electrode active material in the first region 22.

When the first region 22 includes the first particles 30 or the secondary particles 36 thereof, the carbon content of the first region 22 may be characterized by the carbon content of the first particles 30.

### Second Region

The second region 24 contains the second particles 40. The second particle 40 has a particle 42 containing an olivine compound and a carbonaceous coating 44 covering at least a part of the surface thereof. Particles 42 contain 90 mass % or more of the olivine type compound, 95 mass % or more, 98 mass % or more, or 99 mass % or more. The particle 42 may be, for example, a particle containing 1% by mass or less of impurities and the balance of which is made of an olivine-type compound. The olivine-type compound of the second particle 40 may be the same as or different from the olivine-type compound of the first particle 30.

The carbonaceous coating 44, like the carbonaceous coating 34, contributes to the improvement of the electron conductivity. The carbonaceous coating 44 contains a carbonaceous material. As the carbonaceous material, various known carbonaceous materials can be appropriately used in the active material particles of this type. Various aspects of the carbonaceous coating 34 described above can be applied to the carbonaceous coating 44.

The carbon content of the second particles 40 based on the carbonaceous coating 44 is greater than the carbon content of the first particles 30 based on the carbonaceous coating 34. By increasing the carbon content in the second particles 40, the electron conductivity is improved on the positive electrode current collector 10 side. Depending on the carbon content of the first particles 30, the carbon content is, for example, greater than 2.5% by weight. Also, for example, more than 2.0% by weight, more than 1.8% by weight, more than 1.6% by weight, more than 1.4% by weight, can be more than 1.2% by weight, etc. The carbon content of the second particles 40 may be 3% by mass or more, 3.5% by mass or more, 4.0% by mass or more, 4.5% by mass or more, 5.0% by mass or more, or 6% by mass or more. The carbon content of the second particle 40 may be 8.0% by mass or less, 7.0% by mass or less, 6.0% by mass or less, 5.5% by mass or less, 5.0% by mass or less, 4.5% by mass or less, 4.0% by mass or less, 3.5% by mass or less, or 3.0% by mass or less. The carbon content is calculated as the mass ratio of carbon to the total mass of the second particles 40. The carbon content can be measured using a carbon-sulfur analyzer (CS meter).

The second particles 40 may be primary particles, and the primary particles may aggregate to form the secondary particles 46 as a so-called granulated body. When the secondary particles 46 are configured, a diffusion path of lithium ions is easily secured in some cases. In addition, the filling property may be improved.

When the second particles 40 constitute the secondary particles 46 as the primary particles, for example, the mean particle diameter of the second particles 40 is not particularly limited, but may be 40 nm or more. Further, for example, 50 nm or more, 60 nm or more, 80 nm or more. The mean particle diameter of the first particles 30 is also, for example, less than or equal to 150 nm and less than or equal to 100 nm. The average particle diameter of the secondary particles 46 is not particularly limited, but may be, for example, 1 μm or more and 20 μm or less, 2 μm or more and 15 μm or less. The mean particle diameter of the second particles 40 can be determined by small-angle X-ray scattering (Small Angle X-ray Scattering: SAXS). The mean particle diameter of the secondary particles 46 can be determined as D₅₀ (on a volume basis) by the laser diffraction/scattering method.

The shape of the second particles 40 is not particularly limited, but is, for example, spherical. The secondary particles 46 are not particularly limited, but are, for example, spherical.

In the case where the second particles 40 constitute the secondary particles 46, the above-described carbon content is directly applied to the secondary particles 46.

The positive electrode active material in the second region 24 may include an olivine-type compound other than the second particles 40 or the secondary particles 46 thereof or a known layered rock salt-type oxide. Preferably, the content of the second particles 40 or the secondary particles 46 thereof is, for example, 80% by mass or more, 85% by mass or more, 90% by mass or more, 95% by mass or more, 97% by mass or more, 98% by mass or more, or 99% by mass or more with respect to the total mass of the positive electrode active material in the second region 24.

The second region 24 may include the second particle 40 or its secondary particles 46 to characterize the carbon content of the second region 24 with the carbon content of the second particle 40.

### Olivine Compound

The olivine-type compound is represented by Formula (1), which is a general formula.

$${Li}_{α} {Mn}_{a} {Fe}_{b} P {O}_{4} \qquad Expression ( 1 )$$

$$( 0.5 0 \leq α \leq 1.5 , 0 \leq a < 1. , 0 \leq b < 1. , 0.90 \leq a + b \leq 1.1 )$$

In the formula (1), α, a, and b can be appropriately set within the above range. It may be preferable that α is, for example, 0.90 or more and 1.1 or less.

For example, when the olivine-type compound represented by the formula (1) is LMFP, a is, for example, 0<a≤0.80. Further, for example, 0.40 or more, 0.45 or more, 0.50 or more, 0.55 or more, 0.60 or more. Further, from the viewpoint of electron conductivity and ion conductivity, 0.75 or less, 0.70 or less, 0.65 or less, 0.60 or less, 0.55 or less. The range of a can be appropriately selected and set from the lower limit and the upper limit, for example, 0.40 or more and 0.80 or less, 0.50 or more and 0.80 or less, 0.60 or more and 0.80 or less. b is, for example, 0.20≤b<1.0. Further, for example, b is 0.25 or more, 0.30 or more, 0.35 or more, 0.40 or more, and 0.45 or more. b is also, for example, 0.60 or less, 0.55 or less, 0.50 or less, 0.45 or less, 0.40 or less. The range of b can be appropriately selected and set from the lower limit and the upper limit, and can be, for example, 0.20 or more and 0.60 or less, 0.20 or more and 0.50 or less, 0.20 or more and 0.40 or less.

Examples of the olivine-type compound represented by the formula (1) include LMFP and LFP, LMP.

In the present specification, as the doping element, when an element other than the above Mn, Fe is added in the olivine-type compound in an amount of 0.1% by mass or more and 10% by mass or less, it is also intended to be included in the olivine-type compound in the present disclosure.

### Conductive Aid

The mixture layer 20 including the first region 22 and the second region 24 may each contain a conductive auxiliary agent. The conductive auxiliary agent is an auxiliary agent for improving the electron conductivity in the first region 22 and the second region 24. The conductive auxiliary agent is not particularly limited, and various known conductive auxiliary agents can be used. Examples of the conductive auxiliary agent include graphite such as natural graphite and artificial graphite; and carbon black such as acetylene black, Ketjen black, channel black, furnace black, lamp black, and summer black. Examples of the conductive auxiliary agent include conductive fibers such as carbon fibers and metal fibers; carbon materials such as graphene and carbon nanotubes; carbon fluoride; metal powders such as aluminum and nickel powder; conductive whiskers such as zinc oxide and potassium titanate; conductive metal oxides such as titanium oxide; and conductive materials such as polyphenylene derivatives. As the carbon nanotube, for example, a single-wall carbon nanotube (SW-CNT) or a multi-wall carbon nanotube (MW-CNT) including a double-wall carbon nanotube may be preferable. One kind or two or more kinds of these may be used as the conductive auxiliary agent.

The content (total amount) of the conductive auxiliary agent in the mixture layer 20 is not particularly limited, but is, for example, 0.01% by mass or more and 5% by mass or less of the total mass of the mixture layer 20.

### Binder

The mixture layer 20 including the first region 22 and the second region 24 may contain a binder. The binder is not particularly limited, and a known binder used for the positive electrode can be used as appropriate. Examples thereof include polyvinylidene fluoride and styrene-butadiene rubber. One or more of these may be used. The content of the binder in the mixture layer 20 is not particularly limited, but is, for example, 0.3 mass % or more and 10 mass % or less.

The thickness of the mixture layer 20 is not particularly limited, but has, for example, a thickness of about 10 μm or more and 500 μm or less. In addition, the thickness of each of the first region 22 and the second region 24 is not particularly limited, but may be, for example, a thickness that equally divides the thickness of the mixture layer 20 by 2.

The basis weight of the mixture layers 20 is not particularly limited, but is, for example, 15 mg/cm² or more. This is because a high energy density tends to be easily obtained. Also, for example, 20 mg/cm² or more, 25 mg/cm² or more, and 30 mg/cm² or more. Also, for example, 50 mg/cm² or less and 40 mg/cm² or less. Typically, 20 mg/cm² or more and 40 mg/cm² or less.

According to the present specification, there is also provided a secondary battery including such a positive electrode 4 and a stacked electrode element including a separator, a negative electrode, and a negative electrode current collector. A separator, a negative electrode, and a negative electrode current collector can be used as appropriate for the secondary battery.

The mixture layer 20 can further increase the carbonaceous content of the second region 24 by making the carbon content based on the carbonaceous coating 44 of the second particles 40 larger than the carbon content based on the carbonaceous coating 34 of the first particles 30 used in each of the first region 22 and the second region 24. Accordingly, in the secondary battery 100 including the positive electrode 4, it is possible to improve the lithium ion diffusivity in the thickness direction of the positive electrode 4 and contribute to the improvement of the cycle characteristics. In particular, with a simple configuration, the cycle characteristics of the secondary battery 100, in particular, the charge-discharge characteristics for a long time can be improved.

The first particles 30 in the first region 22 and the second particles 40 in the second region 24 may constitute the secondary particles 36 and 46, respectively. In this case, by making the carbon content of the first particles 30 smaller than the carbon content of the second particles 40, the lithium ion diffusivity in the inside of the secondary particles 36 and in the thickness direction of the positive electrode 4 can be effectively improved, which is more meaningful.

By using the particles 30 and 40 having different carbon contents and the secondary particles 36 and 46 as the positive electrode active material particles in the first region 22 and the second region 24, respectively, the lithium ion diffusibility in the positive electrode 4 is improved with a simple configuration. As a result, the cycle characteristics of the secondary battery 100, in particular, the charge-discharge characteristics for a long time can be improved.

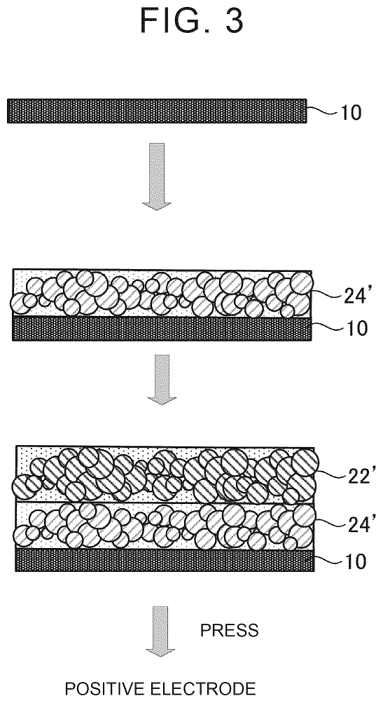

Next, a method of manufacturing the positive electrode 4 will be described with reference to FIG. 3 as appropriate.

In this manufacturing method, the mixture for the positive electrode mixture layer corresponding to the second region 24 is applied to the current collector 10 by a known method such as a doctor blade, and is dried as necessary to prepare the precursor layer 24′ of the second region 24. Further, the composition for the positive electrode mixture layer corresponding to the first region 22 is coated on the precursor layer 24′, and the precursor layer 22′ of the first region 22 is prepared, dried, and pressed. In this way, the positive electrode 4 in a state in which the mixture layer 20 is integrated with the current collector 10 can be obtained.

The mixture for the positive electrode mixture layer corresponding to the second region 24 and the mixture for the positive electrode mixture layer corresponding to the first region 22 can be appropriately prepared using various aspects in the second region 24 and the first region 22 described above, respectively.

According to this manufacturing method, the first region 22 and the second region 24 having different carbon contents based on the carbonaceous coating 34 of the first particles 30 and the carbonaceous coating 44 of the second particles 40 are formed. Simply, the cycle characteristics of the secondary battery 100, in particular, the charge-discharge characteristics for a long time can be improved.

Hereinafter, embodiments embodying the disclosure of the present specification will be described, but the present disclosure is not limited thereto.

### Example 1

In this example, a lithium ion secondary battery was manufactured by the following method, and the cycle characteristics were measured under predetermined conditions. The configurations of the sample and the comparative sample are shown in Table 1.

### (1) Preparation of Positive Electrode

The positive electrodes of Samples 1 to 6 were prepared using positive electrode active material particles as shown in Table 1. That is, as the positive electrode active material, six types of active material particles (secondary particles, mean particle diameter D₅₀ 10 micrometers), which are LMFP (Mn 60 mol %, Fe 40 mol %), and differ in the carbon content (3 levels) and the primary particle diameter (2 levels) of the carbonaceous coating, are prepared. LMFP:Conductive assistant:so that the binder was 94:1.0:5.0 (wt %), each mixture slurry was prepared. The carbon content was measured with a CS meter. These slurries were applied to a current collector (30-μm-thick Al foil) by a doctor blade so that the one-sided basis weight was 28 mg/cm². Thereafter, the resultant was dried at 100° C. for 10 minutes, and pressed to obtain a dense 1.8 g/cc to prepare positive electrodes of Samples 1 to 6.

### (2) Preparation of the Negative Electrode

An artificial graphite (mean particle diameter D₅₀ of 15 micrometers) is used as the negative electrode active material, and a slurry of active material:conductive auxiliary agent:CMC:SBR=97:0.1:0.4:2.5 (wt %) is prepared. Thereafter, the slurry is applied to the 8-μm Cu foil by a doctor blade so that the one-sided basis weight 13 mg/cm² (the ratio of the positive electrode capacity to the negative electrode capacity is 1.1). A negative electrode was prepared by drying at 100° C. for 10 minutes and pressing to a densified 1.25 g/cc.

### (3) Cell Fabrication

A laminated cell was prepared by laminating the positive electrodes of the samples, the separators (three-layer laminate of PP/PE/PP, 16 micrometers), and the negative electrodes. The electrolyte was a mixed system of 1.4-M LiPF₆/FSI and EC:DMC:EMC=30:40:30 (vol %) was used. The constraining force of the cell was taken as 100 kPa.

### (4) Activation and Characterization

The initial charging current was a constant current-constant voltage method, constant current charging was performed up to 4.3 V at the current value of 0.05 C, constant voltage charging was performed until the current value of 0.02 C, and 3.0 V was discharged at the current value of 0.05 C by the constant current method to activate the batteries. After the activation treatment, charging was performed at the current value of 0.05 C to 4.3 V by the constant current-constant voltage method, and discharging was performed at the current value of 2 C to 3.0 V by the constant current method, and the capacity retention ratio with respect to the rated capacity was calculated. The results are also shown in Table 1.

TABLE 1

| | Active material | | | | |
|---|---|---|---|---|---|
| | | Particle | | | 2 C discharge |
| | | diameter of | Particle | | with respect to |
| | | secondary | diameter of | Carbon | rated capacity |
| | Mn/Fe | particle | primary | content | discharge- |
| Sample | mol % | D50 μm | particle | mass % | rate % |
| 1 | 60/40 | 10 | Small | 1.5 | 74.1 |
| 2 | 60/40 | 10 | Small | 2.0 | 68.2 |
| 3 | 60/40 | 10 | Small | 2.5 | 64.6 |
| 4 | 60/40 | 10 | Large | 1.5 | 71.7 |
| 5 | 60/40 | 10 | Large | 2.0 | 69.3 |
| 6 | 60/40 | 10 | Large | 2.5 | 68.2 |

As shown in Table 1, for each of Samples 1 to 6, it was found that the lower the carbon content of the carbonaceous coating, the higher the discharge rate, and the better the long-time performance. That is, when the carbon content of the carbonaceous coating is large with respect to the positive electrode active material particles, it is considered that the excess carbonaceous coating inhibits the diffusibility of lithium ions, and the supply of lithium ions in the electrode thickness direction is insufficient, thereby deteriorating the input/output performance for a long time. It was also found that the input/output performance was not significantly affected by the size of the primary particle size.

The long-term input/output performance of the positive electrode depends in particular on the diffusivity of lithium ions on the separator side. Therefore, it has been found that long-term input/output performance can be improved by using positive electrode active material particles having a low carbon content in the carbonaceous coating so as to improve the diffusivity of lithium ions on the separator side in the positive electrode.

While specific examples of the technology disclosed in the present specification have been described in detail above, these examples are merely illustrative and do not limit the scope of the claims. Various modifications and variations of the specific examples described above are included in the technology described in the claims. The technical elements described in this specification or in the drawings may be used alone or in various combinations, and are not limited to the combinations described in the claims at the time of filing. The technology illustrated in the present specification or the drawings can achieve a plurality of objects at the same time, and has technical usefulness in achieving one of the objects.

What is claimed is:

1. A positive electrode of a lithium ion secondary battery, comprising
a positive electrode mixture layer, wherein:
the positive electrode mixture layer includes
a first region that faces a separator, the first region containing a first particle containing an olivine-type compound having a first carbonaceous coating, and
a second region that faces a current collector, the second region containing a second particle containing an olivine-type compound having a second carbonaceous coating; and
a first carbon content that is a mass ratio of carbon in the first particle based on the first carbonaceous coating is smaller than a second carbon content that is a mass ratio of carbon in the second particle based on the second carbonaceous coating.

2. The positive electrode according to claim 1, wherein the first region contains a secondary particle of the first particle, and the second region contains a secondary particle of the second particle.

3. The positive electrode according to claim 2, wherein the first carbon content of the first particle is 2.5 mass % or less.

4. The positive electrode according to claim 3, wherein a basis weight of the positive electrode mixture layer is 20 mg/cm² or more.

5. A lithium ion secondary battery comprising the positive electrode according to claim 1.
